(19) United States
(12) Patent Application Publication
(10) Pub. No.: US 2025/0216845 A1
(43) Pub. Date: Jul. 3, 2025

(54) INDUSTRIAL PROCESS AUTOMATION SYSTEM WITH FIELD DEVICE LEVEL ANOMALY DETECTION

(71) Applicant: Endress+Hauser Inc., Greenwood, IN (US)

(72) Inventors: Tim Shope, Fuquay-Varina, NC (US); Jason Pennington, Fishers, IN (US); Laurel Kiselis, West Lafayette, IN (US)

(21) Appl. No.: 18/398,340

(22) Filed: Dec. 28, 2023

(51) Int. Cl. G05B 23/02

(52) U.S. Cl. CPC G05B 23/0275; G05B 2223/06

(57) ABSTRACT

An industrial process automation system includes a field device level including a plurality of autonomous field devices, and an edge device. Each of the plurality of field devices includes a signal generating module generating a measurement signal, a diagnostic module generating diagnostic data based on the measurement signal, an anomaly detection algorithm that identifies an anomaly based on the diagnostic data, and a communication module transmitting the anomaly to the edge device and then to a cloud/server.

### TECHNICAL FIELD

The present disclosure relates generally to an industrial process automation system and, more particularly, to an infrastructure supporting anomaly detection at a field device level.

### BACKGROUND

Detecting and diagnosing process disturbances and variabilities requires a lot of time, input data, technologies, and, typically, requires the use of process engineers. Oftentimes, a process historian is involved, collecting and storing data related to industrial operations. Work must be done to ingest the collected data, configure analysis, review and monitor processes to detect variations, and then leverage process knowledge to diagnose issues and create remediation plans. A lot of time and cost is expended in all these efforts.

There remains a need for further contributions in this area of technology.

### SUMMARY

In one aspect of the present disclosure, an industrial process automation system includes a field device level including a plurality of autonomous field devices and an edge device communicatively coupling the autonomous field devices with a cloud/sever. Each of the plurality of field devices includes a signal generating module generating a measurement signal, a diagnostic module generating diagnostic data based on the measurement signal, an anomaly detection algorithm that identifies an anomaly based on the diagnostic data, and a communication module transmitting the diagnostic data to the edge device and ultimately the cloud/server.

### BRIEF DESCRIPTION OF THE DRAWINGS

The described embodiments and other features, advantages and disclosures contained herein, and the manner of attaining them, will become apparent and the present disclosure will be better understood by reference to the following description of various embodiments of the present disclosure taken in conjunction with the accompanying drawings, wherein:

FIG. 1 shows an exemplary diagrammatic view of the different levels of an industrial process automation infrastructure, according to the prior art;

FIG. 2 shows an exemplary diagrammatic view of a historian architecture from the prior art;

FIG. 3 shows a high-level diagrammatic view of an exemplary industrial process automation infrastructure, according to an aspect of the present disclosure;

FIG. 4 shows an exemplary diagrammatic view of process control at the field device level, including anomaly detection;

FIG. 5 illustrates multiple anomalies detected across multiple field devices; and

FIG. 6 shows a perspective view of an industrial plant, including the identification of multiple anomalies detected, according to the industrial process automation infrastructure of the present disclosure.

In the figures, the same features are identified by the same reference signs.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

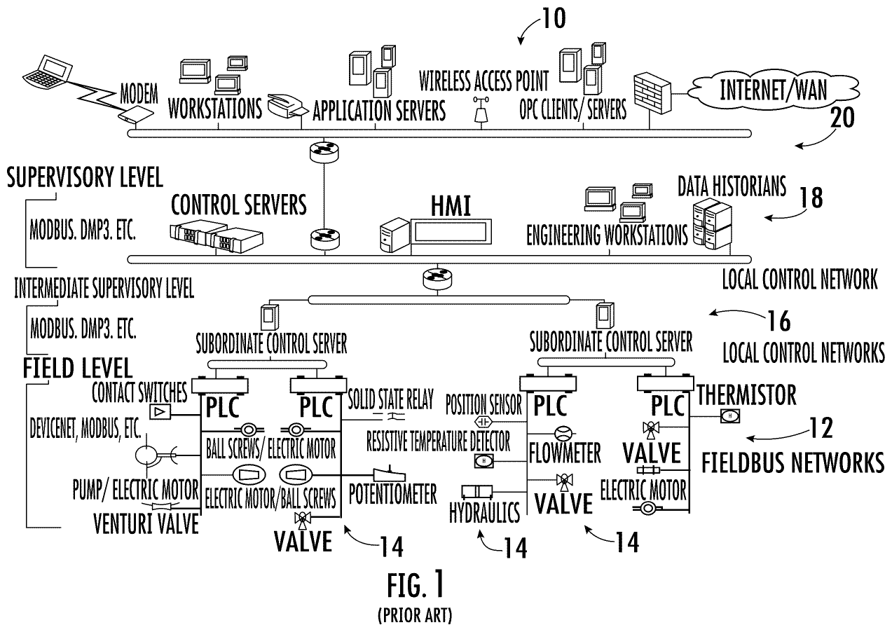

FIG. 1 shows a diagrammatic view of an industrial process automation infrastructure 10, according to the prior art. The term industrial process automation is used to describe different types of control systems and associated instrumentation, which include the devices, systems, networks, and controls used to operate and/or automate industrial processes.

A field device level 12 is typically the lowest automation hierarchy level and is made up of field devices 14 such as actuators and sensors, or other electronic devices. Sensors capture data (e.g., data on temperature, pressure, etc.) and transfer it via fieldbuses to a connected field device, which in turn transmits control data through actuators to controlling elements. For example, a control level 16 is made up of automation devices that receive process signals from the sensors and trigger actuator control based on the process signals. The control devices at this level typically have little or no on-board intelligence.

Programmable logic controllers (PLCs) and distributed control systems (DCSs) are the most widely used and durable industrial controllers that can deliver automatic control functions based on sensor inputs. They consist of various modules such as the CPU, analog and digital I/Os, and communication modules, which let technicians program control functions or strategies that carry out certain automatic operations or processes.

A supervisory level 18 includes automatic monitoring systems for facilitating control of functions. Data is gathered from the lower level of the automation hierarchy, which is used to carry out analysis and supervisory control. This level typically includes software programs that analyze the historical data for anomalies. An enterprise level 20 is the top level of the automation hierarchy and typically includes one or more management tools used to assess enterprise performance. This level is where most of the analysis occurs to identify anomalies or other issues.

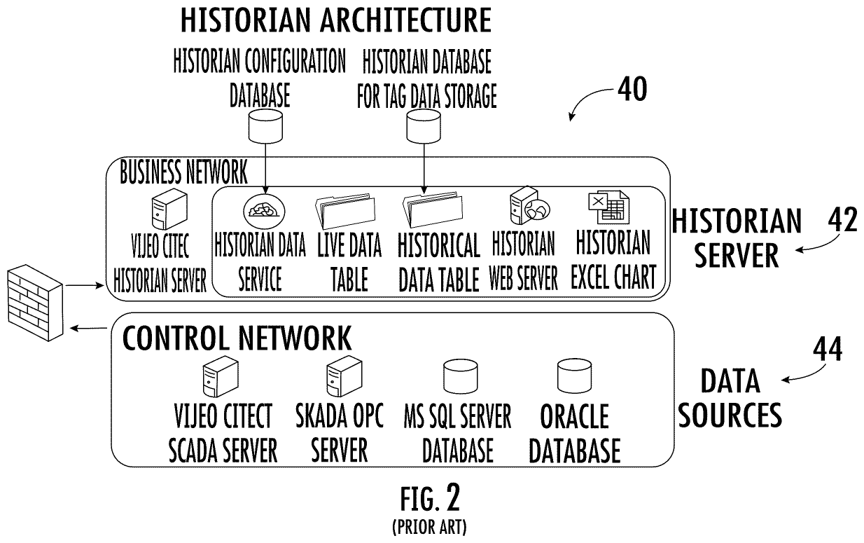

The enterprise level 20 is shown and referenced as a data historian in FIG. 2. A data historian is a collection of specialized software solutions, including components 42, that are commonly used in industrial settings to efficiently store and track data from sources 44 such as, for example, the PLCs referenced above. It processes data from a wide variety of sources and produces a variety of metrics.

With the current solutions, several technologies are relied upon to detect and/or diagnose process disturbances and variability. In addition to data historian's, these include control loop performance monitors, spreadsheets, FFTs, power spectrums, cross correlation of responses, etc. All of this requires engineering effort to ingest the data, configure the analysis, manually review and monitor processes to detect variations, leverage process domain knowledge to diagnose the issue and create a remediation plan. All of this is done at a large monetary cost in infrastructure, installation, software license, human effort, and a knowledgeable workforce.

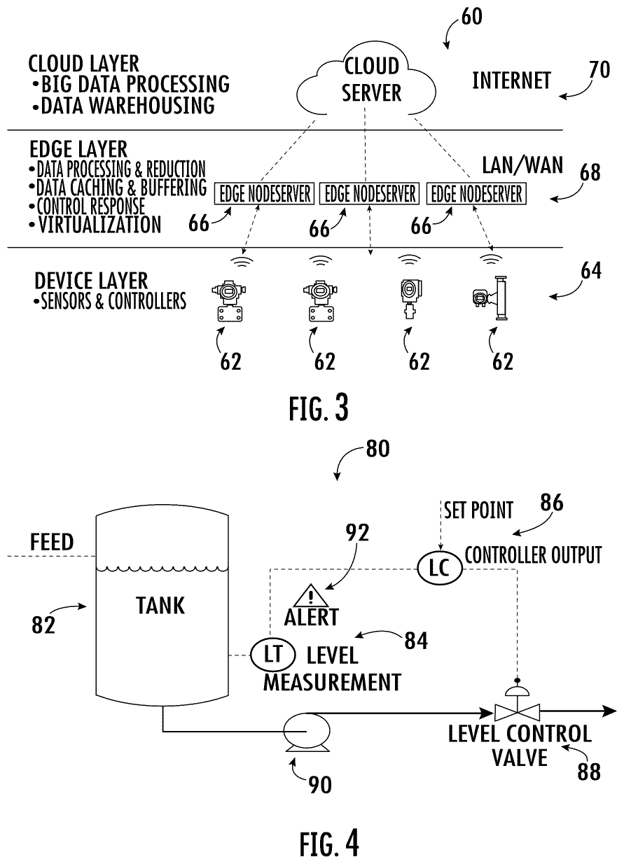

FIG. 3 shows a high-level diagrammatic view 60 of an exemplary industrial process automation system, including a plurality of autonomous field devices 62, at a field device level 64, according to an aspect of the present disclosure. Field devices 62 may include sensors, actuators, instruments, motors, values, switches, and other equipment. At the least, these devices 62 may collect and process data in real time from the environment for a long period of time. Field devices 62 may include devices that may be external to the field device and connected, such as by a 4-20 ma connection.

Field devices 62 have more “intelligence” than the field devices 14 described above. That is, devices at the field device level 64 of FIG. 3 are autonomous, such that they are configured to detect process abnormalities autonomously. The additional intelligence consists generally of an anomaly detection framework. This includes, for example, an algorithm that compares current operation to “normal” operation to identify anomalies, such as FFT, and other, normal operational signatures.

Edge devices 66, at edge layer 68, have many purposes, but at their core, they serve as entry or exit points and control the flow of data at the boundary or perimeter between two networks, such as between the field device level 64 and a cloud/server layer 70, which includes various cloud components.

Some edge device functions might include the transmission, routing, processing, monitoring, filtering, translation, reduction, caching, buffering and storage of data between networks. Traditional edge devices include edge routers, routing switches, firewalls, multiplexers, and other wide area network (WAN) devices. Intelligent edge devices have built-in processors with onboard analytics or artificial intelligence capabilities.

FIG. 4 depicts an exemplary control loop process 80, which may include automatic medium level control. A tank sensor 84 may be placed in the tank or container that is being monitored. It detects the medium level and sends a signal to the control unit 86. The control unit 86 then processes the signal and sends a command to the valve 88 to open or close.

Specifically, when the level of the medium in the tank drops below the set level, the medium level sensor 84 sends a signal to the control unit 86, which then sends a command to the valve 88 to open. This allows medium to flow into the tank until the desired level is reached, at which point the medium level sensor 84 sends a signal to the control unit 86 to close the valve 88. Pump 90 may also be used to control flow of the medium.

According to the present disclosure, anomaly detection may occur at this field device level. The field devices, or devices attached thereto, may include an anomaly detection framework, which includes, for example, one or more algorithms that compare current operation to “normal” operation to identify anomalies, such as FFT, and other, normal operational signatures.

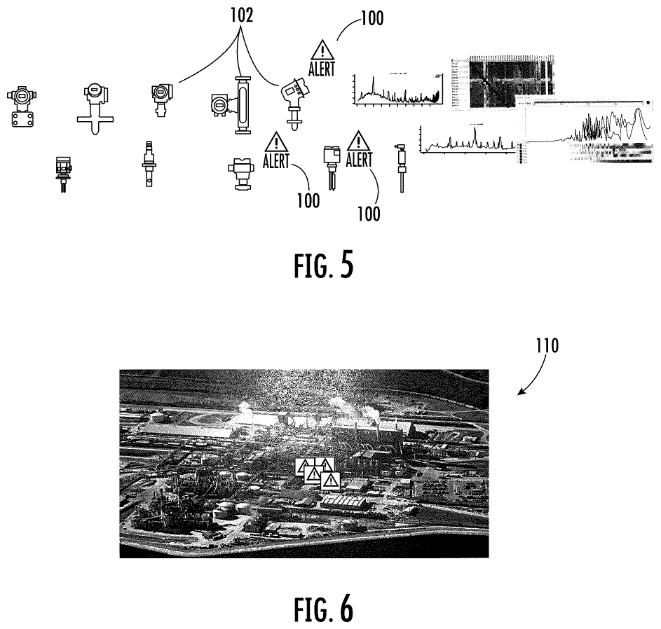

FIG. 5 illustrates multiple anomalies 100 being detected across multiple field devices 102. The present disclosure describes an infrastructure that includes execution of applications on or near the field devices 102, to achieve faster response times and capture real-time data. This technology is able to capture and store data in real time at or near the field device level, allowing for detailed analysis of the production process. It also provides a comprehensive view of the entire production cycle, enabling effective troubleshooting and optimization. This data can be utilized for predictive maintenance, system optimization, anomaly detection, as well as issuing early warning signals to operators when something is amiss. The data can also be used for trend analysis and forecasting purposes to identify upcoming changes in the system's behavior.

FIG. 6 shows a perspective view of an industrial plant, or a process disturbance map 110, including identifications of anomalies detected, according to the industrial process automation infrastructure of the present disclosure. The process disturbance map depicts locations of anomalies to gain insight as to a process disturbance in near real-time.

With multiple instruments installed across a process facility connected to the internet/cloud, abnormal process facility connected to the Internet/cloud, abnormal process conditions would be detected autonomously and supported by multiple instruments. Platform would be scalable from small OEM machine building applications to larger enterprise visions.

Process conditions would be detected and mapped to process/unit operations. Interactions and cross correlation would be identified readily and direct operations/maintenance staff to quick restitution of the issue driving increased process efficiencies.

Process operations could be monitored remotely, and regional resources could be used instead of local site engineers, further reducing cost and adding efficiencies. Inventory, Raw Material Consumption, Quality, OEE, Downtime could all be metrices in a cloud-based environment with a low code/no code environment.

While various embodiments of an industrial process automation infrastructure and methods for using and constructing the same have been described in detail herein, the embodiments are merely offered by way of non-limiting examples of the disclosure described herein. It will therefore be understood that various changes and modifications may be made, and equivalents may be substituted for elements thereof, without departing from the scope of the disclosure. The present disclosure is not intended to be exhaustive or to limit the scope of the subject matter of the disclosure.

1. An industrial process automation system, including:
a field device level including a plurality of autonomous field devices; and
an edge device controlling data flow between the field device level and a cloud/server level;
wherein each of the plurality of autonomous field devices includes:
a signal generating module generating a measurement signal;
a diagnostic module generating diagnostic data based on the measurement signal;
an anomaly detection algorithm identifying an anomaly based on the diagnostic data; and
a communication module transmitting the anomaly to the edge device diagnostic data to the edge device and then to the cloud/server level.

2. The industrial process automation system of claim 1, wherein each of the plurality of autonomous field devices has a global positioning system (GPS) location, wherein the GPS location is transmitted with the anomaly to the edge device.

3. The industrial process automation system of claim 2, wherein the edge device or the cloud/server level is configured to display a map of the industrial process automation system identifying locations of anomalies throughout the system.

4. The industrial process automation system of claim 1, wherein at least one of the plurality of autonomous field devices includes a sensor configured to detect temperature, pressure, level, or flow in a process.

5. The industrial process automation system of claim 1, wherein the anomaly detection algorithm includes a machine learning algorithm.

6. The industrial process automation system of claim 1, wherein the anomaly detection algorithm is based on a comparison of the received diagnosis data with an expected value.

7. The industrial process automation system of claim 1, wherein the plurality of autonomous field devices and the edge device communicate via an industrial wireless communication protocol.

8. The industrial process automation system of claim 1, wherein the anomaly detection algorithm is configured to detect variations of the measurement signals outside of the normal operating range.

9. The industrial process automation system of claim 1, wherein the anomaly detection algorithm generates a process disturbance map illustrating multiple anomalies.
